(19) United States
(12) Patent Application Publication
(10) Pub. No.: US 2004/0240758 A1
(43) Pub. Date: Dec. 2, 2004

(54) Bearing element

(76) Inventors: Juergen Heuberger, Sinsheim (DE); Herbert Rubel, Sinsheim-Weiler (DE)

Correspondence Address: Paul J Vincent, Dreiss Fuhlendorf Steimle & Becker, Postfach 10 37 62, Stuttgart, D 70032, DE

(21) Appl. No.: 10/489,361

(22) PCT Filed: Aug. 5, 2002
(86) PCT No.: PCT/EP02/08707

(51) Int. Cl. F16C 9/02; F16C 35/00

(52) U.S. Cl. 384/294; 384/430

(57) ABSTRACT

The invention relates to a semicircular bearing element comprising a supporting layer (5) and a sliding layer (7) which is applied to the same. A holding element (6) projecting from a side of the supporting layer (5) facing away from the sliding layer (7) is provided, said holding element engaging in a correspondingly embodied recess (10) in a bearing housing element (2) in order to anchor the bearing element in the mounted state. The aim of the invention is to simplify the production and assembly of the bearing element. To this end, the holding element (6) is embodied in a polygonal manner in a cross-sectional plane, perpendicular to a radial direction (8) of the bearing element.

The invention concerns a bearing element, in particular for bearing levers to control automotive vehicles or combustion engines thereof, comprising a supporting layer and a sliding layer which is disposed thereon, wherein a holding element is provided which projects from a side of the supporting layer facing away from the sliding layer and engages in a correspondingly formed recess in a bearing housing part to anchor the bearing element in the mounted state such that it cannot rotate relative thereto.

Bearing elements of the type mentioned herein should not rotate in the peripheral direction during operation, e.g. for bearing a brake lever. Conventionally, a holding element is provided on the side of the bearing element facing away from the sliding layer, which engages in a recess in the bearing housing part. This enables arrangement of the bearing element and bearing housing part such that they do not rotate relative to each other. It is generally difficult to produce the holding element and recess, which require precise fitting and substantially play-free fixing of the bearing element.

It is therefore the underlying purpose of the present invention to reduce the construction effort and production and mounting accuracy of bearing elements without increasing the cost.

This object is achieved in accordance with the invention with a bearing element of this type, in that the holding element has a polygonal shape in a cross-sectional plane perpendicular to the radial direction of the bearing element. In a particularly advantageous fashion, the holding element has a shape with between 5 and 9 corners, preferably 6 to 9 corners and, in particular, an octagonal shape.

This permits construction of a recess in the bearing housing part, which preferably has a continuous circumferential surface with preferably circular cross-section and having inner dimensions which are slightly smaller than the outer dimensions of the polygonal holding element. The bearing element can be inserted with its polygonal holding element in this slightly smaller recess, thereby slightly plastically deforming the inner wall of the recess and/or the corner edges of the polygonal shape such that the bearing shell is disposed on the bearing housing part without play to eliminate noise production during operation. In view of the highly precise production and classification of bearing elements and bearing housing part recesses, the effort required for manufacture is considerably reduced.

In a particularly advantageous arrangement of the bearing element and the bearing housing part, the inner diameter of the preferably circular recess is slightly smaller than the lowest value of the diameter of the periphery of the polygonal shape of the holding element, as is given by taking into consideration production tolerances. This ensures that the bearing element is received or mounted on the bearing housing part without play.

Moreover, it is particularly advantageous when the recess is stepped or chamfered in a region of transition to a bearing receiving surface.

Further features, details and advantages of the invention can be extracted from the enclosed claims, the drawing, and the following description of a preferred embodiment of the invention.

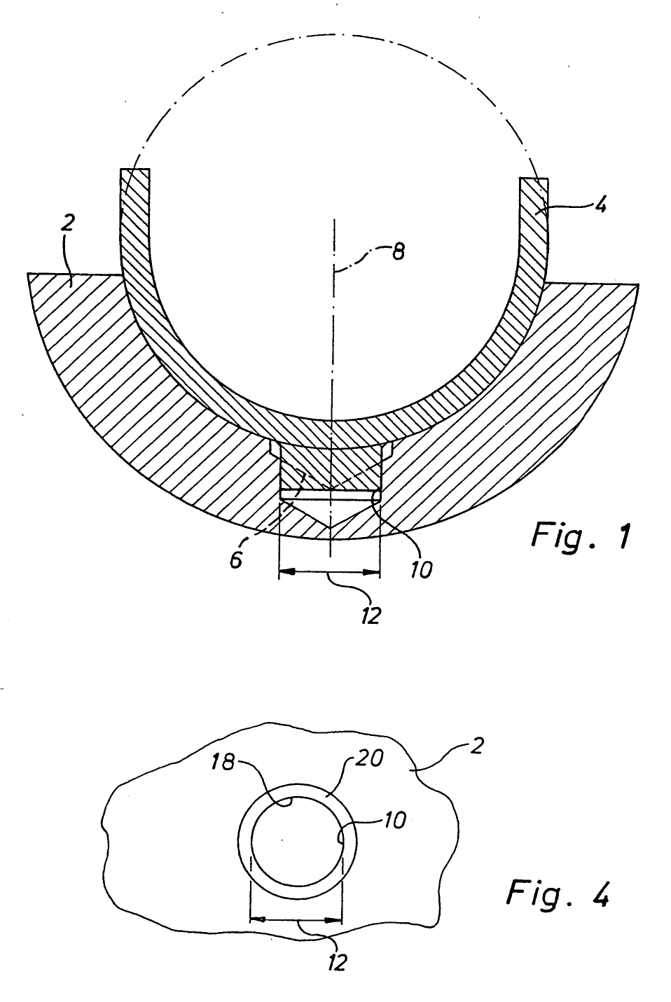

FIG. 1 schematically shows a section through a bearing housing part with mounted bearing element;

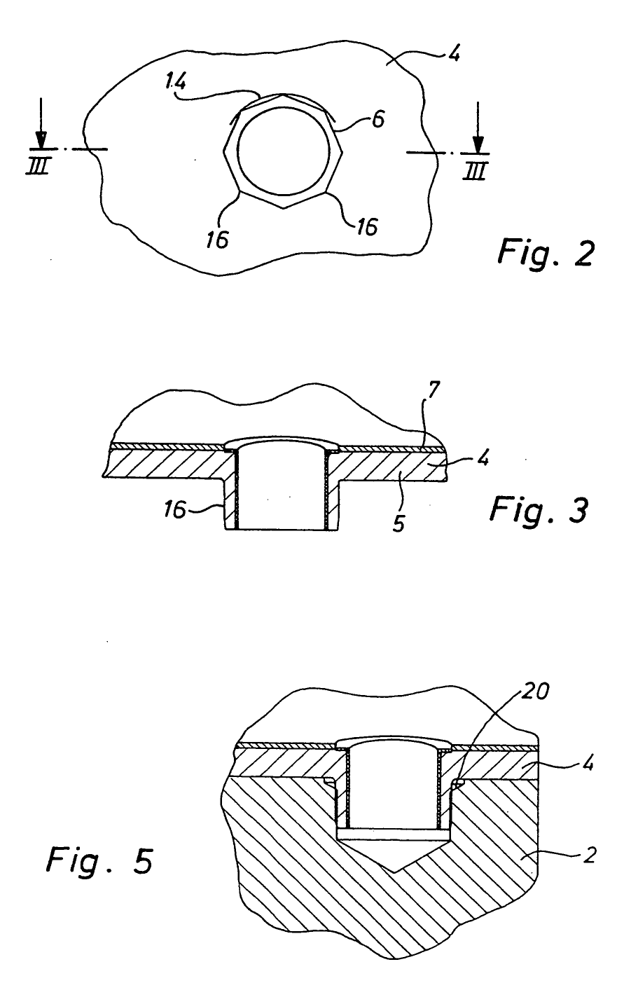

FIG. 2 shows a detail plan view of the back of the bearing element, with one holding element;

FIG. 3 shows a detail section of the bearing element with the plane of intersection corresponding to the arrows III-III of FIG. 2;

FIG. 4 shows a detail plan view of the bearing housing part with a recess;

FIG. 5 shows a detail section through a bearing housing part with mounted bearing element and enlarged recess.

FIG. 1 schematically shows a section of the bearing housing part 2 with mounted bearing element 4 having a supporting layer 5 of steel and a sliding layer 7 which is applied thereon, which faces the sliding partner (not shown).

The side of the bearing element 4 facing away from the sliding partner has a holding element 6 which has a polygonal, i.e. octagonal outer contour in a plane perpendicular to the radial direction 8 of the bearing element (shown in FIGS. 2 and 3).

The holding element 6 engages in a round recess 10 in the bearing housing part 2. The round recess 10 has an inner diameter 12 which is slightly smaller than the periphery 14 of the holding element 6, thereby obtaining play-free arrangement of the bearing element 4 on the bearing housing part 2. When the bearing element 4 is mounted to the bearing housing part 2, the material is slightly plastically deformed through cooperation of the corner edges 16 of the polygonal holding element 6 with the inner wall 18 of the bearing housing part 2 to obtain a play-free arrangement and compensate for small dimensioning errors. The corner edges 16 dig into the inner wall 18 or the corner edges 16 are deformed, thereby producing material flow against the pressing direction of the holding element 6. Advantageously, the recess 10 has a widening 20 in the form of a step or chamfer (shown in FIGS. 4 and 5) which can receive the material flow.

1-11. cancelled.

12. A semicircular bearing element for mounting to a bearing housing part, the bearing housing part having a recess, the bearing element comprising:
a supporting layer;
a sliding layer applied onto said supporting layer; and
a holding element projecting from a side of said supporting layer facing away from said sliding layer, said holding element being formed in a punch and dye procedure to acquire an outer polygonal shape in a cross-sectional plane perpendicular to a radial direction of the bearing element, said polygonal shape being structured and dimensioned to cooperated with an inner surface of the recess in the bearing housing part to anchor the bearing element in the bearing housing part such that it cannot rotate relative thereto.

13. The bearing element of claim 12, wherein said polygonal shape has between 5 and 9 corners.

14. The bearing element of claim 13, wherein said polygonal shape has between 6 and 9 corners.

15. The bearing element of claim 14, wherein said polygonal shape is octagonal.

16. A semicircular bearing system, comprising:
a bearing housing part having a recess, said recess having a round shape in a cross sectional plane perpendicular to a radial direction of the bearing system, said recess having an inner diameter; and
a bearing element, said bearing element having a supporting layer and a sliding layer applied onto said supporting layer, said bearing element also having a holding element projecting from a side of said supporting layer facing away from said sliding layer, said holding element being formed in a punch and dye procedure to acquire an outer polygonal shape in said cross-sectional plane perpendicular to said radial direction of the bearing system, said polygonal shape being structured and dimensioned to cooperated with an inner surface of said recess in said bearing housing part to anchor said bearing element in said bearing housing part such that it cannot rotate relative thereto, wherein said polygonal shape has an outer peripheral diameter which is slightly larger than said inner diameter of said recess.

17. The system of claim 16, wherein said inner diameter of said recess is selected such that an upper limit of said inner diameter is smaller than a lower limit of said peripheral diameter of said polygonal shape of said holding element, taking into consideration error tolerances during production.

18. The system of claim 16, wherein said peripheral diameter of said polygonal shape is 4-8 mm and said inner diameter of said recess smaller by 0.05-0.15 mm.

19. The system of claim 16, wherein said peripheral diameter of said polygonal shape and said inner diameter of said recess are selected such that a pressing force of 310-2200 N is required for pressing said holding element into said recess during mounting of said bearing element to said bearing housing part.

20. The system of claim 16, wherein a releasing of said holding element from said bearing housing part requires a removing force of 40 to 420 N.

21. The system of claim 16, wherein said recess has a step or chamfer in a transfer region to a bearing receiving surface.
